(19) United States
(12) Patent Application Publication
(10) Pub. No.: US 2016/0186327 A1
(43) Pub. Date: Jun. 30, 2016

(54) Method for forming a circuit pattern on a substrate

(71) Applicant: Taiwan Green Point Enterprises Co., Ltd., Taichung City (TW)

(72) Inventors: Sheng-Hung Yi, Taichung City (TW); Pen-Yi Liao, Taichung City (TW)

(73) Assignee: Taiwan Green Point Enterprises Co., Ltd., Taichung City (TW)

(21) Appl. No.: 14/757,611

(22) Filed: Dec. 23, 2015

(30) Foreign Application Priority Data
Dec. 24, 2014 (TW) 103145260

(51) Int. Cl. C23C 18/31; C23C 18/16; B05D 1/02

(52) U.S. Cl. CPC C23C 18/31; B05D 1/02; C23C 18/1689

(57) ABSTRACT

A method for forming a circuit pattern on a substrate may include the steps of: providing a substrate having an insulating surface including a pattern-forming region; printing only on a portion of the insulating surface, including the pattern-forming region, with an activation ink so as to form an activation layer on the portion of the insulating surface; forming a first metal layer on the activation layer by electroless plating; and isolating a patterned portion of the first metal layer, which is formed on the pattern-forming region, from a remaining portion of the first metal layer.

### CROSS-REFERENCE TO RELATED APPLICATION

This application claims priority of Taiwanese Patent Application No. 103145260, filed on Dec. 24, 2014.

### FIELD

Embodiments of the present disclosure generally relate to a method for forming a circuit pattern on a substrate, more particularly to a method for forming a circuit pattern onto an insulating surface of a substrate.

### BACKGROUND

One approach for forming a circuit pattern on a substrate includes the steps of: roughening an insulating surface of a substrate; forming a whole layer of activation material onto the insulating surface of the substrate; removing the activation material located outside a pattern-forming region by laser ablation; forming a first metal layer on the layer of activation material by electroless plating; and forming a second metal layer on the first metal layer by electroplating.

However, such an approach may result in relatively high production costs since forming the whole layer of activation material is relatively expensive. Moreover, the step of removing the activation material may be time consuming and lead to oxidation of the remaining activation material, thereby lowering the production yield of the conventional approach.

### SUMMARY

Certain embodiments of the disclosure provide a method for forming a circuit pattern that may alleviate at least one of the aforementioned drawbacks of the prior art. Such a method may include the steps of: providing a substrate having an insulating surface including a pattern-forming region; printing only on a portion of the insulating surface including the pattern-forming region with an activation ink, so as to form an activation layer on the portion of the insulating surface; forming a first metal layer on the activation layer by electroless plating; and isolating a patterned portion of the first metal layer, which is formed on the pattern-forming region, from a remaining portion of the first metal layer.

### BRIEF DESCRIPTION OF THE DRAWINGS

Other features and advantages of the disclosure will become apparent in the following detailed description of the exemplary embodiment with reference to the accompanying drawings, of which:

FIG. 1 is a flow chart illustrating an embodiment of a method for forming a circuit pattern on a substrate;

FIG. 2 is a schematic view, illustrating providing a substrate having an insulating surface;

FIG. 3 is a schematic view, illustrating forming an activation layer on a portion of the insulating surface;

FIG. 4 is a sectional view taken along Line IV-IV of FIG. 3;

FIG. 5 is a schematic view illustrating forming a first metal layer on the activation layer;

FIG. 6 is a sectional view taken along Line VI-VI of FIG. 5;

FIG. 7 is a schematic view illustrating isolating a patterned portion of the first metal layer from a remaining portion of the first metal layer;

FIG. 8 is sectional view taken along Line VIII-VIII of FIG. 7;

FIG. 9 is a schematic view illustrating forming a second metal layer onto the patterned portion of the first metal layer;

FIG. 10 is a sectional view taken along Line X-X of FIG. 9;

FIG. 11 is a schematic view illustrating removing the remaining portion of the first metal layer;

FIG. 12 is a sectional view taken along Line XII-XII of FIG. 11;

FIG. 13 is a schematic view illustrating removing part of the activation layer which is outside a pattern-forming region of the insulating surface;

FIG. 14 is a schematic view illustrating the circuit pattern formed on the insulating surface of the substrate; and

FIG. 15 is a schematic view of one embodiment, illustrating that the substrate has a metal base layer, and an insulating layer formed on the metal base layer to provide the insulating surface.

### DETAILED DESCRIPTION

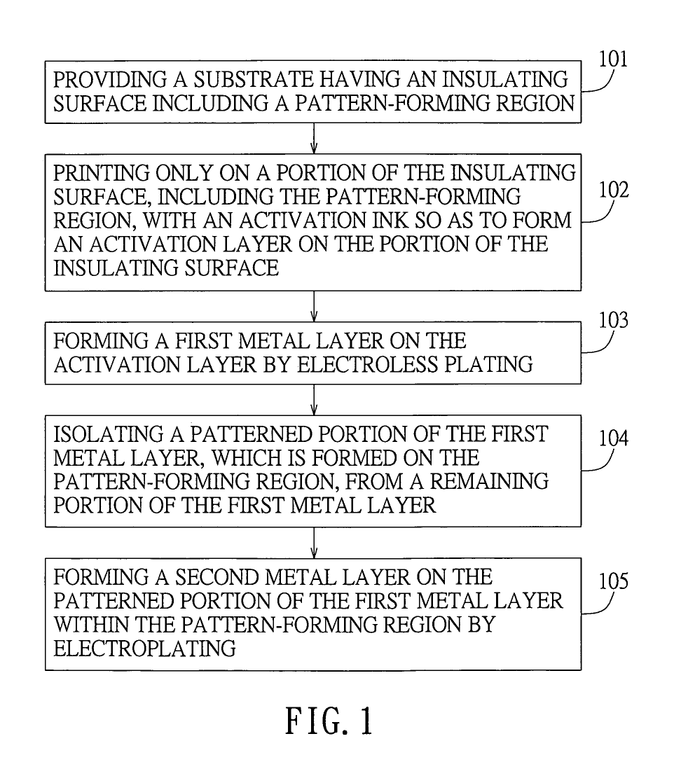

Referring to FIG. 1, one exemplary embodiment of a method for forming a circuit pattern on a substrate may include the steps as follows.

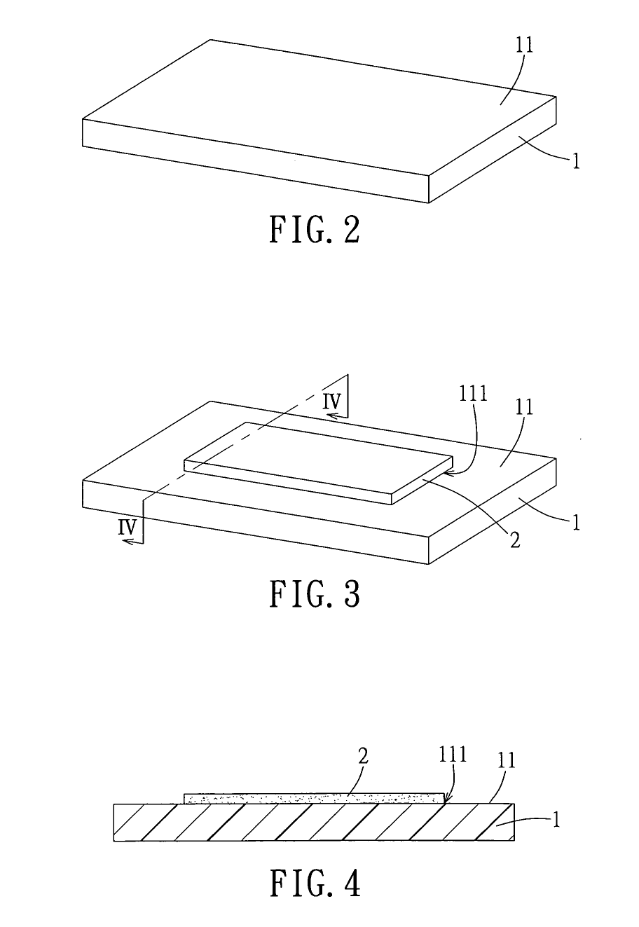

Step 101: providing a substrate 1 having an insulating surface 11 as illustrated in FIGS. 2 and 3. The substrate 1 may be made of an insulating material, such as plastics, and may be part of a product, such as a cell phone, a touch panel, a watch, glasses, etc. In certain embodiments, the substrate 1 may include a metal base layer 12, and an insulating layer 13 formed on the metal base layer 12 to provide the insulating surface 11 as illustrated in FIG. 15. In such embodiments, the insulating layer 13 may be formed by spray coating, screen printing, transferring, or the like, and may be made of insulating paints or inks. It may be noted that the insulating surface 11 is not limited to being planar, i.e., the insulating surface 11 may be a curved surface.

Step 102: printing only on a portion 111 of the insulating surface 11 of the substrate 1 with an activation ink as illustrated in FIGS. 3 and 4, so as to form an activation layer 2 on the portion 111 of the insulating surface 11. The portion 111 of the insulating surface 11 includes a pattern-forming region to be formed with the circuit pattern. In certain embodiments, the activation layer 2 may include a catalyst metal element which is selected from the group consisting of palladium, rhodium, platinum, silver, and combinations thereof. In certain embodiments, the activation layer 2 may be made of a metal oxide compound that is electrically non-conductive. It is worth noting that Step 102 may be conducted by digital printing, screen printing, pad printing, transfer printing, coating, spraying, or powder coating techniques, and is not limited thereto according to the present disclosure.

It is worth noting that, in certain embodiments, the activation ink may include N-methyl-2-pyrrolidone (NMP) which can slightly etch the insulating surface 11 when the same is being applied onto the insulating surface 11. As such, a conventional step of roughening the insulating surface to increase the bonding strength between the activation layer 2 and the insulating surface 11 can be omitted.

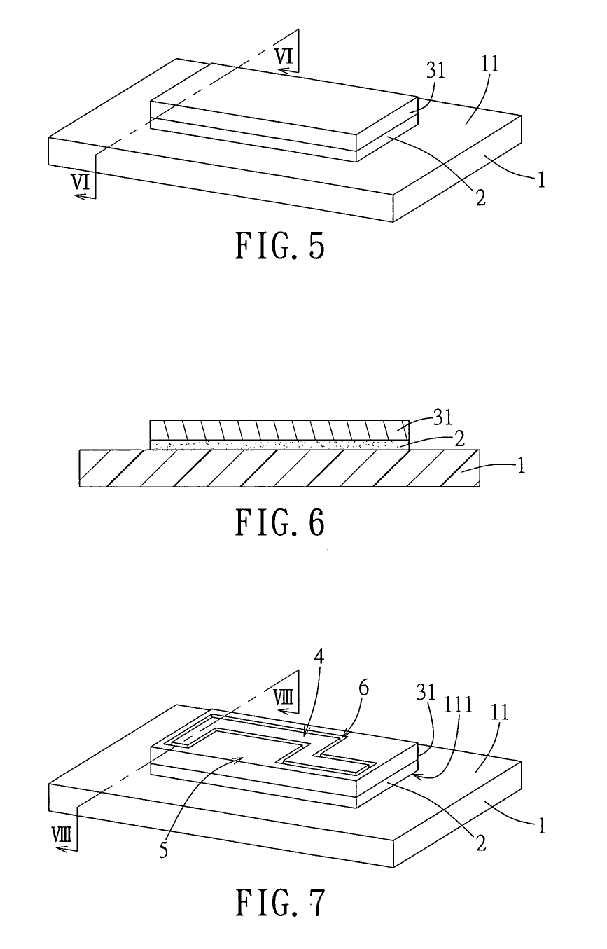

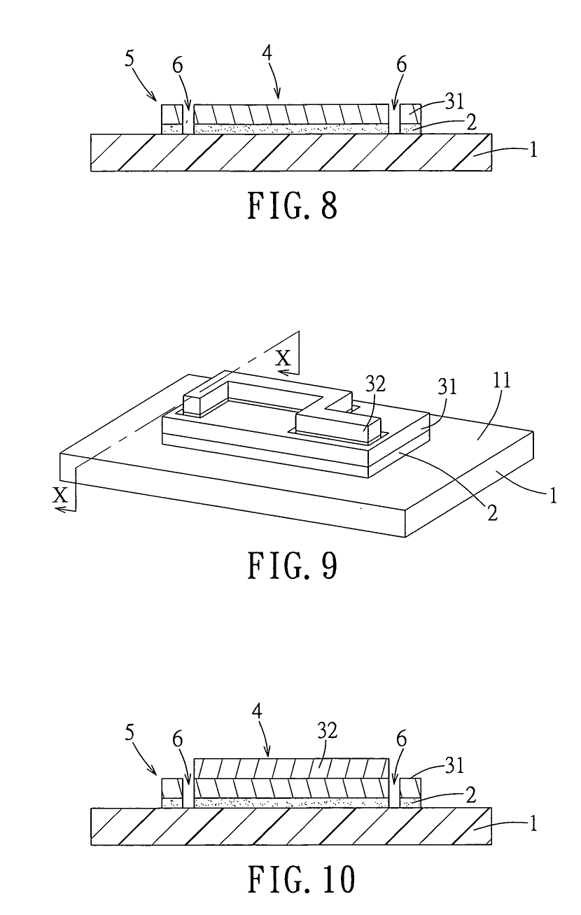

Step 103: forming a first metal layer 31 on the activation layer 2 by electroless plating as illustrated in FIGS. 5 and 6. In certain embodiments, Step 103 may be conducted by placing the substrate 1 with the activation layer 2 into an electroless plating solution for a predetermined period of time, so as to perform the electroless plating reaction. In certain embodiments, the first metal layer 31 may have a thickness ranging from 0.1 μm to 0.25 μm. In certain embodiments, the first metal layer 31 may be made of nickel, but is not limited thereto according to the present disclosure. For instance, the first metal layer 31 may be made of copper in certain embodiments.

Step 104: isolating a patterned portion 4 of the first metal layer 31, which is formed on the pattern-forming region, from a remaining portion 5 of the first metal layer 31. In certain embodiments, Step 104 may include removing part of the first metal layer 31, so as to form a gap 6 along an outer periphery of the pattern-forming region to isolate the patterned portion 4 of the first metal layer 31. The removal of the part of the first metal layer 31 may be conducted by laser ablation. In certain embodiments, the patterned portion 4 of the first metal layer 31 may be surrounded by the remaining portion 5 of the first metal layer 31. It may be noted that, Step 104 may further include isolating a patterned portion of the activation layer 2, e.g., by laser ablation, where the patterned portion of the activation layer 2 is formed on the pattern-forming region and corresponds in position to the patterned portion 4 of the first metal layer 31. However, in certain embodiments where the activation layer 2 is electrically non-conductive, the gap 6 does not need to extend into the activation layer 2 considering the subsequent electroplating process.

Step 105: forming a second metal layer 32 on the patterned portion 4 of the first metal layer 31 within the pattern-forming region, as illustrated in FIGS. 9 and 10, by electroplating. In certain embodiments, the second metal layer 32 may be made of copper, i.e., using copper-containing electroplating solution with copper electrodes during the electroplating process. In certain embodiments, the second metal layer 32 may have a thickness ranging from 0.2 μm to 0.5 μm. Since the patterned portion 4 of the first metal layer 31 is isolated from the remaining portion 5, the second metal layer 32 can only be formed on the patterned portion 4 of the first metal layer 31 during the electroplating process.

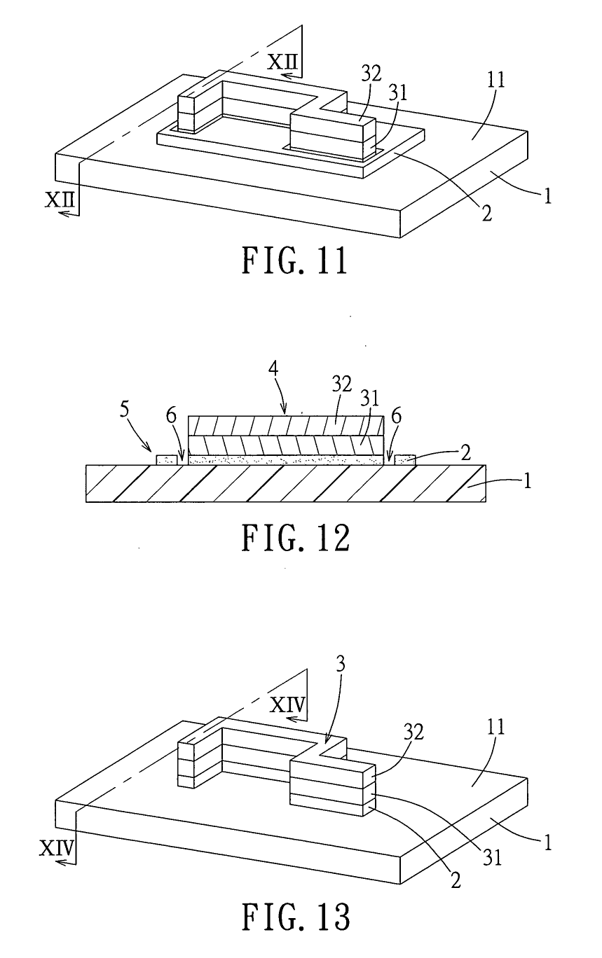

In certain embodiments, the method may further include a step of removing the remaining portion 5 of the first metal layer 31 which is located outside the pattern-forming region of the insulating surface 11 as illustrated in FIGS. 11 and 12, so as to form the circuit pattern on the substrate 1. Such a step may be performed by wet-etching techniques or laser ablation and is not limited thereto according to the present disclosure.

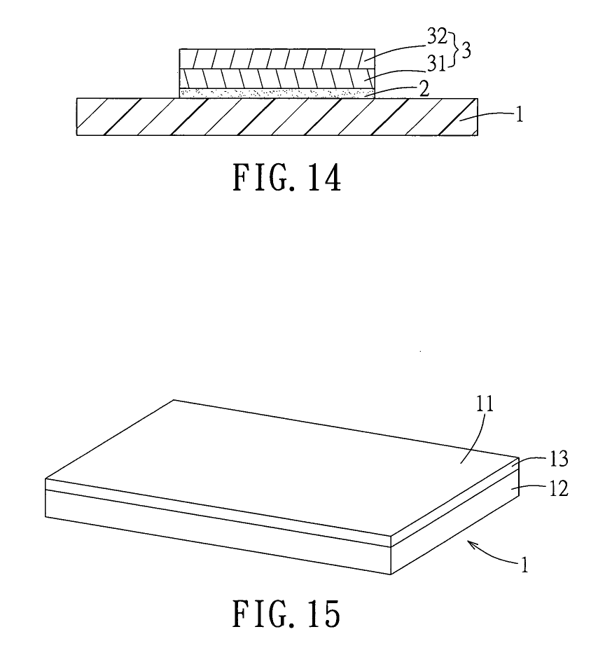

In certain embodiments, the method may further include a step of removing part of the activation layer 2 which is located outside the pattern-forming region of the insulating surface 11 as illustrated in FIGS. 13 and 14, so as to form the circuit pattern 3 on the substrate 1. Such a step may be performed by applying a stripping solution onto the substrate 1, e.g., by spraying the stripping solution onto the substrate 1 or by dipping the substrate 1 into the stripping solution. As such, the activation layer 2 is softened due to the stripping solution, and the bonding between the activation layer 2 and the insulating surface 11 of the substrate 1 is diminished, thereby allowing the same to be removed from the insulating surface 11 of the substrate 1. In certain embodiments, the step of removing the activation layer 2 may be conducted by laser ablation.

By forming the activation layer 2 only on the portion 111 of the insulating surface 11 in the method according to the present disclosure, the aforesaid drawbacks of the prior art can be prevented.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for forming a circuit pattern on a substrate, comprising the steps of:
providing a substrate having an insulating surface including a pattern-forming region;
printing only on a portion of the insulating surface, including the pattern-forming region, with an activation ink, so as to form an activation layer on the portion of the insulating surface;
forming a first metal layer on the activation layer by electroless plating; and
isolating a patterned portion of the first metal layer, which is formed on the pattern-forming region, from a remaining portion of the first metal layer.

2. The method of claim 1, wherein the step of printing with the activation ink is conducted by one of digital printing, screen printing, pad printing, transfer printing, coating, spraying, and powder coating.

3. The method of claim 1, wherein the step of isolating the patterned portion of the first metal layer is conducted by laser ablation.

4. The method of claim 3, wherein the step of isolating the patterned portion of the first metal layer includes removing part of the first metal layer along an outer periphery of the pattern-forming region, so as to form a gap to isolate the patterned portion of the first metal layer.

5. The method of claim 3, further comprising a step of isolating a patterned portion of the activation layer which is formed in the pattern-forming region and which corresponds in position to the patterned portion of the first metal layer.

6. The method of claim 1, wherein the activation layer is electrically non-conductive.

7. The method of claim 1, wherein the substrate includes a metal base layer, and an insulating layer formed on the metal base layer to provide the insulating surface.

8. The method of claim 1, further comprising a step of forming a second metal layer on the patterned portion of the first metal layer by electroplating.

9. The method of claim 1, wherein the patterned portion of the first metal layer is surrounded by the remaining portion of the first metal layer.

10. The method of claim 1, wherein the activation ink includes N-methyl-2-pyrrolidone.
